(19) United States
(12) Patent Application Publication
(10) Pub. No.: US 2017/0245664 A1
(43) Pub. Date: Aug. 31, 2017

(54) DUAL DENSITY MOLDED FOAM PILLOW

(71) Applicant: Tempur-Pedic Management, LLC, Lexington, KY (US)

(72) Inventor: James T. Ives, Church Hill, TN (US)

(73) Assignee: Tempur-Pedic Management, LLC, Lexington, KY (US)

(21) Appl. No.: 15/511,144

(22) PCT Filed: Sep. 29, 2015
(86) PCT No.: PCT/US2015/052839

§ 371 Date: Mar. 14, 2017

Related U.S. Application Data
(60) Provisional application No. 62/057,646, filed on Sep. 30, 2014.

(51) Int. Cl. A47G 9/10; B29C 44/06

(52) U.S. Cl. CPC A47G 9/109; A47G 9/1036; B29C 44/06; A47G 2009/1018; B29K 2105/04

(57) ABSTRACT

A pillow includes an inferior portion and an outer portion. The interior portion is comprised of a first flexible foam, while the outer portion is comprised of a second flexible foam having a density different than that of the first flexible foam. Methods of producing a pillow are also provided whereby either a first foam precursor is dispensed into a central portion of a mold to provided a first flexible foam, or a pre-formed foam insert comprised of a first flexible foam is placed into a central portion of a mold. A second foam precursor is then subsequently dispensed into a peripheral portion of the mold to produce a second flexible foam having a density different than that of the first flexible foam. Upon reaction and expansion of the foam precursors, a molded foam pillow is produced having dual densities.

### RELATED APPLICATIONS

This application claims priority to U.S. Provisional Application Ser. No. 62/057,646, filed Sep. 30, 2014, the entire disclosure of which is incorporated herein by this reference.

### TECHNICAL FIELD

The present invention relates to a dual density molded foam pillow and method of producing the same. In particular, the present invention relates to a molded foam pillow including an interior portion with a density different than that of an outer portion of the pillow.

### BACKGROUND

As is generally the case with support cushions, the effectiveness and desirability of the support cushion is partly a function of how well the support cushion supports the body of a user and partly a function of how well the support cushion conforms to the body of a user and provides a feeling of softness. In this regard, many users find support cushions, and in particular pillows, which are soft to be particularly desirable for supporting the head of the user as such support cushions significantly deform and cradle the head of the user to provide an increased feeling of softness. That deformation and increased feeling of softness, however, is often accompanied by a lack of support for the neck and shoulders of the user. Alternatively though, while many users find support cushions and, in particular, pillows, that are firm, to be particularly desirable for supporting the neck and shoulders of the user, such firm support cushions can be overly hard, and thus, undesirable, for supporting the head of the user.

### SUMMARY

The present invention includes a dual density molded foam pillow and method of producing the same. In particular, the present invention relates to a molded foam pillow including an interior portion with a density different than that of an outer portion of the pillow.

In one exemplary embodiment of the present invention, a support cushion in the form of a pillow is provided that includes an interior portion defining a perimeter. The pillow further includes an outer portion that extends around the perimeter of the interior portion of the pillow, with the interior portion having a generally rectangular shape and being flush with the outer portion of the pillow on the both the first side and the second side of the pillow to create a substantially continuous exterior surface. In this regard, the interior portion extends through the entire width of the pillow from the first side to the second side of the pillow and allows either the first side or the second side of the pillow to serve as the primary surface upon which the head of a user is supported.

In the exemplary pillow, the interior portion and the outer portion are generally comprised of a flexible foam (e.g., a visco-elastic foam) with the density of the interior portion typically being different than the density of the outer portion. In particular, the density of the flexible foam used in the outer portion, typically has a density sufficient for supporting the neck and shoulders of a user. The flexible foam comprising the interior portion, on the other hand, typically has a density less than that or the outer portion and is suitable tor supporting and providing a feeling of softness to the head of the user. For example, in certain embodiments, an exemplary pillow includes an outer portion that is comprised of visco-elastic foam with a density of about 70 kg/m³ to about 110 kg/m³ and a hardness of about 25 N to about 50 N, while the interior portion is comprised of a visco-elastic foam with a density of about 30 kg/m³ to about 50 kg/m³ and a hardness of about 5 N to about 25 N. In some embodiments, an exemplary pillow includes an outer portion that is comprised of visco-elastic foam with a density of about 100 kg/m³ and a hardness of about 45 N, while the interior portion is comprised of a visco-elastic foam with a density of about 40 kg/m³ and a hardness of about 10 N.

As a refinement, the exemplary pillows of the present invention can also be provided in various other configurations that similarly provide a feeling of softness to the head of a user and support to the neck and shoulders of a user, but yet do not include an interior portion that is flush with the outer portion on both sides of the pillow. For instance, in another exemplary embodiment, a support cushion in the form of a flexible foam pillow is provided that includes an oval-shaped, interior portion defining a perimeter and an outer portion that surrounds the perimeter of the interior portion of the pillow. The oval-shaped interior portion of this further exemplary pillow is also comprised of a flexible foam having a density less the flexible foam comprising the outer portion of the pillow. In this further pillow, however, the interior portion is not Hush with the outer portion on both sides of the pillow. Rather, in the pillow, the interior portion is recessed into an upper, first side of the pillow, white a lower, second side of the pillow is substantially flat. In this regard, to provide added support to the neck of a user and to provide an ergonomic surface on which a user can rest, in some embodiments, the pillow further includes four divots that each have an ovular shape and are positioned along the outer portion of the pillow such, that the divots are configured to support the neck of a user when the user is resting on the first side of the pillow and the head of the particular user is lying on the recessed interior portion of the pillow.

In another exemplary embodiment of the present invention that makes use of a recessed interior portion, a flexible foam pillow is provided that also includes an interior portion recessed into a first side of the pillow and that is entirely surrounded by an outer portion comprised of flexible foam having a density greater than that forming the interior portion. To provide support to the neck and shoulders of a user, however, the pillow does not make use of divots positioned in the outer portion. Instead, in the pillow, the outer portion is raised relative to the interior portion with different sides of the raised outer portion having varying heights. In use, the exemplary pillow can thus be arranged, depending on user preferences, such that an increased amount of support is provided if a neck of a user is positioned on one side of the outer portion, while a lesser amount of support is provided if a neck of a user is positioned on another side of the outer portion of the pillow.

In yet further embodiments of the present invention that make use of an interior portion and an outer portion comprised of flexible foams having different densities, exemplary pillows are also provided that support the neck and shoulders of a user without the outer portion of the exemplary pillows extending around the entirety of the perimeter of the interior portion of the pillow. For instance, in another embodiment of the present invention, a pillow is provided that includes an interior portion and an outer portion that, rather than extending entirely around the interior portion, is divided into an upper area and a lower area that extend longitudinally along opposite skies of the pillow, with the interior portion then extending longitudinally between the upper area and the lower area of the pillow. In such a pillow, the interior portion of the pillow is again comprised of a less dense, softer flexible foam to provide a suitable surface for the head of a user, while the upper area and the lower area of the outer portion, of the pillow are comprised of a denser flexible foam to support the neck and shoulders of a user. In this additional pillow, however, a first transition portion and a second transition portion are further included and are placed between the interior portion and the upper area of the outer portion and between the interior portion and the lower area of the outer portion, respectively. In this regard, the first transition portion and the second transition portion are each also comprised of a flexible foam, but are typically comprised of a flexible foam having a density and/or hardness less than that of the outer portion of the pillow and greater than that of the interior portion of the pillow. As such, by including a first transition portion and a second transition portion in the pillow, a user resting on the pillow is provided with an amount of firmness and support that gradually decreases from the outer portion to the interior portion of the pillow.

Regardless of the particular type of support cushion contemplated by the present invention, each of the exemplary support cushions described herein are typically produced by making use of a foam molding system. In one exemplary implementation of a method for producing a pillow, a foam molding system is first provided. The foam molding system comprises a top mold and a bottom mold, with the top mold defining a recessed portion and the bottom mold similarly defining a recessed portion. When the top mold is then secured to the bottom mold, the recessed portion of the top mold and the recessed portion of the bottom mold align with one another to form a single internal cavity that in, in turn, is the negative of the pillow produced by the foam molding system.

Upon providing the foam molding system, a first Foam precursor is then dispensed into a central, portion of the bottom mold. After the first foam, precursor Is dispensed into a central, portion of the bottom mold, a second foam precursor is then dispensed into a peripheral portion of the mold. After dispensing the first and second foam precursors into the bottom mold, the top mold is then secured to the bottom mold. Upon securing the top mold to the bottom mold, the first and second foam precursors are then allowed to expand and completely fill the internal cavity formed from the recessed portions of the top mold and the bottom mold. After the first and second foam precursor expands, the first and second foam precursors then set in the foam molding system such that the expanded foam formed from the first foam precursor is bonded to or otherwise combines with, the expanded foam formed from the second foam precursor. After the foam precursor has reacted for an appropriate amount of time and the first and second foam precursors have set, a pillow is thereby formed and can then be removed from the foam molding system.

In an alternative method for producing a pillow in accordance with the present invention, a foam molding system is also first provided. In this alternative implementation, however, rather than dispensing a first foam precursor into the mold, upon providing the foam molding system, a foam insert that has previously been produced is placed into a central portion of the bottom mold. After the foam insert is placed into a central portion of the bottom mold, a foam precursor is then dispensed into the bottom mold around, the foam insert. Then, after dispensing the foam precursor into the bottom mold around the foam insert, the top mold is secured to the bottom mold. Upon securing the top mold to the bottom mold, the foam precursor is then allowed to expand and completely fill the internal cavity formed from the recessed portions of the top mold and the bottom mold. After the foam precursor expands, the foam precursor then sets in the foam molding system such that the resulting expanded foam is bonded to the foam insert. Subsequently, after the foam precursor has been allowed to react for an appropriate amount of time and the foam precursor has set, an exemplary pillow of the present invention is thereby formed wherein the foam insert forms the interior portion of the exemplary pillow and the set foam precursor forms the outer portion of the exemplary pillow. The pillow can then be removed, from the foam molding system.

Further features and advantages of the present invention will become evident to those of ordinary skill in the art after a study of the description, figures, and non-limiting examples in this document

### BRIEF DESCRIPTION OF THE DRAWINGS

FIG. 1A is a perspective view of an exemplary pillow made in accordance with the present invention and including an interior portion and an outer portion having different densities;

FIG. 1B is another perspective view of the exemplary pillow shown in FIG. 1, but with a portion of the pillow removed to further illustrate the interior portion and outer portion of the pillow;

FIG. 2 is a perspective view of another exemplary pillow made in accordance with the present invention, including an interior portion and an outer portion, but having a contoured shape;

FIG. 3 is a perspective view of another exemplary pillow made in accordance with the present invention, including an interior portion and an outer portion, but having a recessed interior portion;

FIG. 4 is a perspective view of another exemplary pillow made in accordance with the present invention, including an interior portion and an outer portion, but having a raised

outer portion;

FIG. 5 is a perspective view of another exemplary pillow made in accordance with the present invention, including an interior portion and an outer portion, and further including transition portions positioned between the interior portion and the outer portion of the pillow;

FIG. 6 is a perspective view of another exemplary pillow made in accordance with the present invention, including an interior portion and an outer portion, and also including transition portions positioned between the interior portion and outer portion of the pillow;

FIG. 7 is a flowchart showing an exemplary implementation of a method of producing a pillow in accordance with the present invention; and

FIG. 8 is a flowchart showing another exemplary implementation of a method of producing the pillow in accordance with the present invention.

### DESCRIPTION OF EXEMPLARY EMBODIMENTS

The present invention includes a dual density molded foam pillow and method of producing the same. In particular, the present invention relates to a molded foam pillow including an interior portion with a density different than that of an outer portion of the pillow.

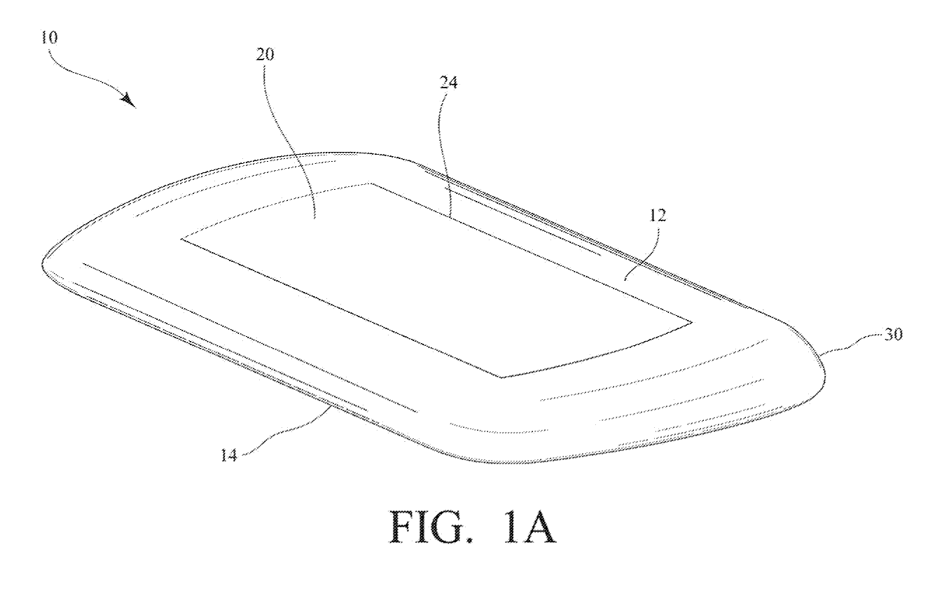

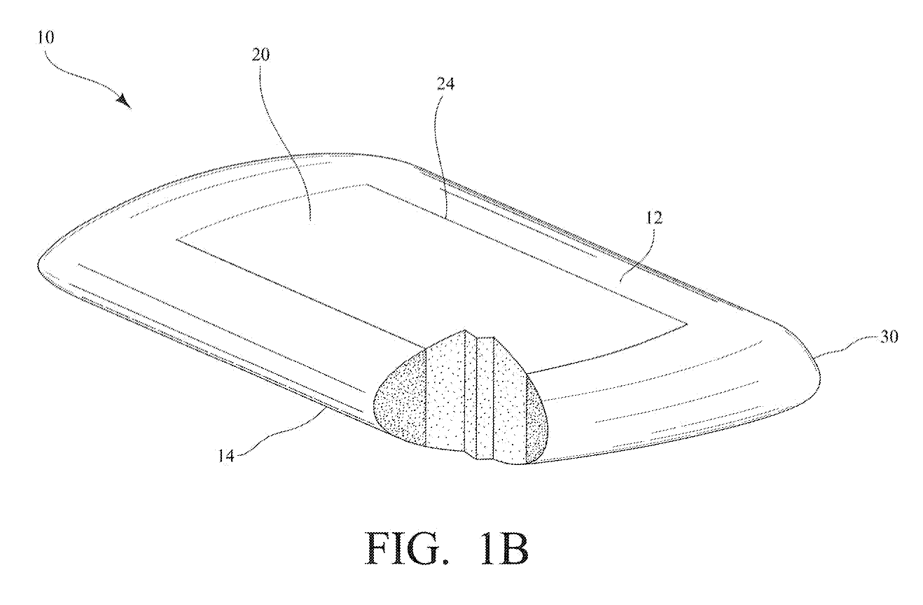

Referring first to FIGS. 1A-1B, in one exemplary embodiment of the present invention, a support cushion in the form of a pillow 10 is provided that includes an interior portion 20 defining a perimeter 24. The pillow 10 further includes an outer portion 30 that extends around the perimeter 24 of the interior portion 20 of the pillow 10, with the interior portion 20 having a generally rectangular shape and being flush with the outer portion 30 of the pillow 10 on the both the first side 12 and the second side 14 of the pillow 10 to create a substantially continuous exterior surface of the pillow 10. In this regard, in the pillow 10, the interior portion 20 extends through the entire width of the pillow 10 from the first side 12 to the second side 14 of the pillow 10 and thus allows either the first side 12 or the second side 14 of the pillow 10 to serve as the primary surface upon which the head of a user is supported. Of course, different configurations of the interior portion and the outer portion of an exemplary pillow, including interior portions having different shapes or extending through the pillow to a different degree, are also contemplated to be within the scope of the present invention.

Regardless of the particular configuration of the interior portion 20 and the outer portion 30 of the pillow 10, the interior portion 20 is generally comprised of first flexible foam and the outer portion 30 is generally comprised of a second flexible foam having a density different than, that of the first flexible foam so as to provide differing support to the head of a user, which would generally be resting on the interior portion 20, and to the neck and shoulders of a user, which would generally be resting on the outer portion 30. Various flexible foams that are capable of suitably distributing pressure from a user's body or portion thereof across the pillow 10 can be used in this regard including, but not limited to, latex, foam, reticulated or non-reticulated visco-elastic foam (sometimes referred to as memory foam or low-resilience foam), reticulated or non-reticulated non-visco-elastic foam, polyurethane high-resilience foam, expanded polymer foams (e.g., expanded ethylene vinyl acetate, polypropylene, polystyrene, or polyethylene), and the like.

In the embodiment shown in FIGS. 1A-1B, the first flexible foam comprising the interior portion 20 and second flexible foam comprising the outer portion 30 of the pillow 10 are both comprised of a visco-elastic foam having a sufficient density and hardness for supporting the head, neck, and shoulders of the user. Generally, such visco-elastic foams have a hardness of at least about 10 N to no greater than about 80 N, as measured by exerting pressure from a plate against a sample of the material to a compression of at least 40% of an original thickness of the material at approximately room temperature (i.e., 21° C. to 23° C.), where the 40% compression is held for a set period of time as established by the International Organization of Standardization (ISO) 2439 hardness measuring standard, in some embodiments, the visco-elastic foam comprising the interior portion 20 or the outer portion 30 has a hardness of about 5 H about 10 N, about 15 N, about 20 N, about 25 N about 30 N, about 35 N, about 40 N about 45 N, or about 50 N to provide a desired degree of comfort and body-conforming qualities.

The visco-elastic foam described herein for use in the interior portion 20 and the outer portion 30 of the pillow 10 can also have a density that assists in providing a desired degree of comfort and body-conforming qualities, as well as an increased degree of material durability. In some embodiments, the density of the visco-elastic foam used in the interior portion 20 and the outer portion 30 has a density of no less than about 30 kg/m³ to no greater than about 110 kg/m³. In some embodiments, the density of the visco-elastic foam used in the interior portion 20 or the outer portion 30 of the pillow 10 is about 30 kg/m³, about 40 kg/m³, about 50 kg/m³, about 60 kg/m³, about 70 kg/m³, about 80 kg/m³, about 90 kg/m³, about 100 kg/m³, or about 110 kg/m³. Of course, the selection of a visco-elastic foam having a particular density will affect other characteristics of the foam, including its hardness, the manner in which the foam responds to pressure, and the overall feel of the foam, but it is appreciated that a visco-elastic foam having a desired density and hardness can readily be selected for an interior portion and an outer portion of an exemplary pillow or for a particular application as desired.

With further respect to the density and hardness of the pillow 10, as indicated above, the density of the interior portion 20 is typically different than the density of the outer portion 30. In particular, in the pillow 10 shown in FIG. 1, the density of the visco-elastic foam used in the outer portion 30 typically has a density sufficient for supporting the neck and shoulders of a user. The visco-elastic foam comprising the interior portion 20, on the other hand, typically has a density less than the outer portion 30 and is suitable for supporting and providing a feeling of softness to the head of the user. For example, in certain embodiments, the pillow 10 includes an outer portion 30 that is comprised of visco-elastic foam with a density of about 70 kg/m³ to about 110 kg/m³ and a hardness of about 25 N to about 50 N, while the interior portion 20 is comprised of a visco-elastic foam with a density of about 30 kg/m³ to about 50 kg/m³ and a hardness of about 5 N to about 25 N. In some embodiments, the pillow 10 includes an outer portion 30 that is comprised of visco-elastic foam with a density of about 100 kg/m³ and a hardness of about 45 N, white the Interior portion 20 is comprised of a visco-elastic foam with a density of about 40 kg/m³ and a hardness of about 10 N.

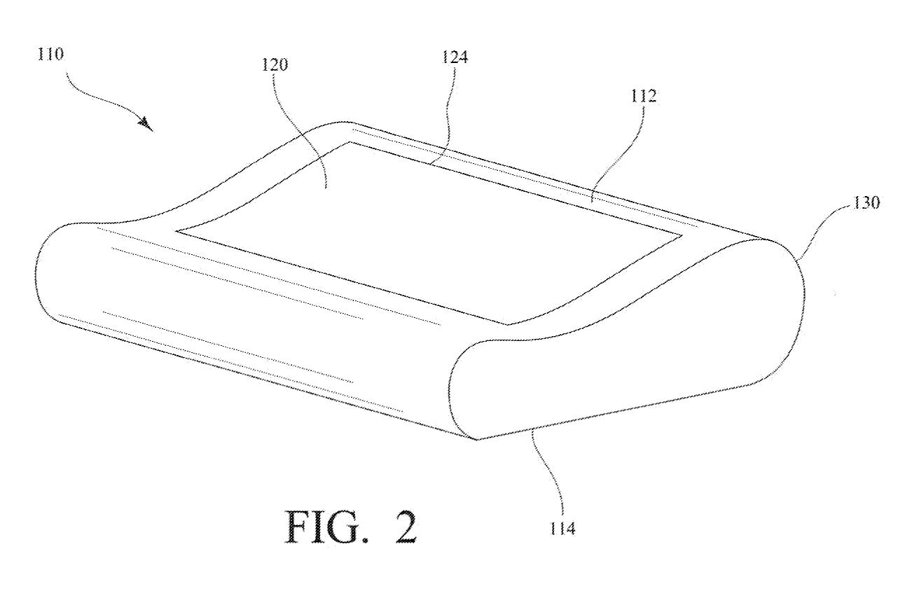

Referring now to FIG. 2, in another exemplary embodiment of the present invention, a support cushion in the form of a flexible foam pillow 110 is provided that also includes a less dense interior portion 120 defining a perimeter 124 and a denser outer portion 130 that extends around the perimeter 124 of the interior portion 120 of the pillow 110. Like the pillow 10 shown in FIG. 1, the interior portion 120 is generally rectangular and is flush with a first side 112 of the pillow 110. Unlike the pillow 10 shown in FIG. 1, how-even the pillow 110 has a contoured shape or profile along the first side 112 of the pillow 110 that acts to align, the head, neck and shoulders of a user lying on the pillow 110, and a flattened second side 114 opposite the first side 112 that provides a stable base for the pillow 110.

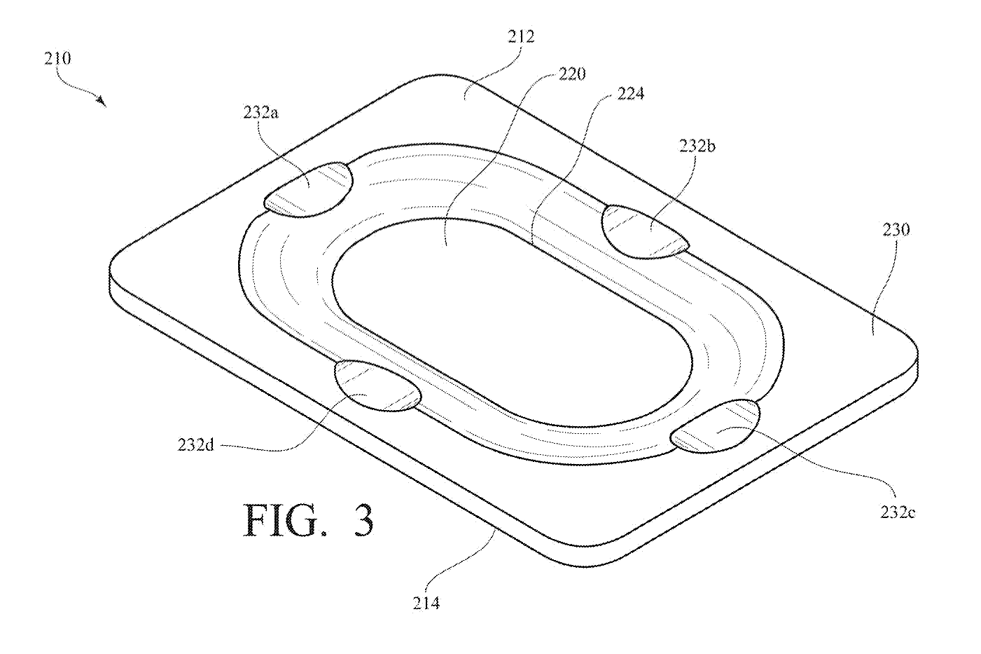

As a refinement, the exemplary pillows of the present invention can also be provided in various other configurations that similarly provide a feeling of softness to the head of a user and support to the neck and shoulders of a user, but yet do not include an interior portion that is flush with the outer portion on both sides of the pillow. For instance, as shown in FIG. 3, in another exemplary embodiment, a support cushion in the form of a flexible foam pillow 210 is provided that includes an oval-shaped interior portion 220 defining a perimeter 224 and an outer portion 230 that surrounds the perimeter 224 of the interior portion 220 of the pillow 210. Similar to the pillows 10, 110 described herein above with reference to FIGS. 1A-1B and 2, the oval-shaped interior portion 220 of the pillow 210 is comprised of a flexible foam having a density Jess the flexible foam comprising the outer portion 230 of the pillow 210. In the pillow 210, however, the interior portion 220 is not flush with the outer portion 230 on both sides of the pillow 210. Rather, in the pillow 210, the interior portion 220 is recessed into an upper, first side 212 of the pillow, while a lower, second side 214 of the pillow 210 is substantially flat. In this regard, to provide added support to the neck of a user and to provide an ergonomic surface on which a user can rest, the pillow 210 further includes four divots 232a, 232b, 232c, 232d that each have an ovular shape and are positioned along the outer portion 230 of the pillow 210 such that the divots 232a, 232b, 232c, 232d are configured to support the neck of a user when the user is resting on the first side 212 of the pillow and the head of the particular user is lying on the recessed interior portion 220 of the pillow 210.

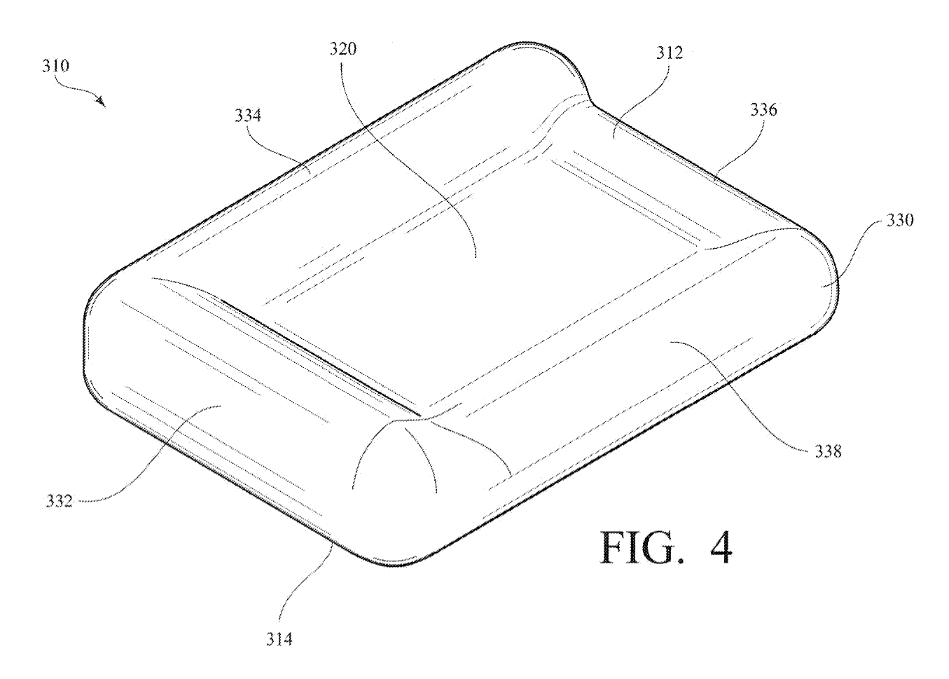

Referring now to FIG. 4, in another exemplary embodiment of the present invention that makes use of a recessed interior portion, a support cushion in the form of a flexible foam pillow 310 is provided that includes an Interior portion 320 recessed into a first side 312 of the pillow 310 and that is entirely surrounded by an outer portion 330 comprised of flexible foam having a density greater than that forming the interior portion 320. To provide support to the neck and shoulders of a user, however, the pillow 310 does not make use of divots positioned in the outer portion 330. Instead, in the pillow 310, the outer portion 330 is raised relative to the interior portion 320 and includes a first side 332, a second side 334, a third side 336, and a fourth side 338. In particular, in the pillow 310, the first side 332 and the second side 334 of the outer portion 330 are continuous with one another and each have the same height, while the third side 336 and the fourth side 338 of the outer portion 330 are continuous with one another and extend to a height that is less that the height of the first side 332 and the second side 334 of the outer portion 330 of the pillow 310. In this regard, the exemplary pillow 310 can thus be arranged, depending on user preferences, such that an increased amount of support is provided if a neck of a user is positioned on the first side 332 or the second side 334 of the outer portion 330, while a lesser amount of support (relative to the support provided by the first side 332 and second side 334) is provided if a neck of a user is positioned on the third side 336 or fourth side 338 of the outer portion 330 of the pillow 310.

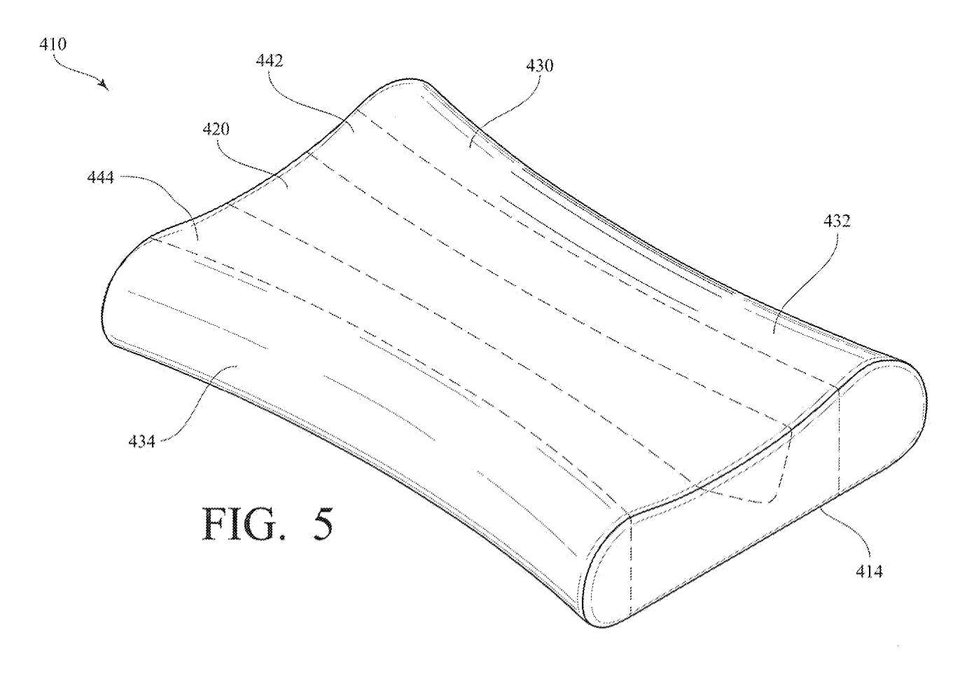

In yet further embodiments of the present invention that make use of an interior portion and an outer portion comprised of flexible foams having different densities, exemplary pillows can also be provided to support the neck and shoulders of a user without the outer portion of the exemplary pillows extending around the entirety of the perimeter of the interior portion of the pillow. For instance, and referring now to FIG. 5, in another embodiment of the present invention, a pillow 410 is provided that includes an interior portion 420 and an outer portion 430 that, rather than extending entirely around the interior portion 420, is divided into an upper area 432 and a lower area 434 that extend longitudinally along opposite sides of the pillow 410, with the interior portion 420 then extending longitudinally between the upper area 432 and the lower area 434 of the pillow 410.

In the pillow 410, and referring still to FIG. 5, the interior portion 420 of the pillow 410 is again comprised of a less dense, softer flexible foam to provide a suitable surface for the head of a user, while the upper area 432 and the lower area 434 of the outer portion 430 of the pillow 410 are comprised of a denser flexible foam to support the neck and shoulders of a user. In the pillow 410, however, a first transition portion 442 and a second transition portion 444 are further included and are placed between the interior portion 420 and the upper area 432 of the outer portion 430 and between the interior portion 420 and the lower area 434 of the outer portion 430, respectively. The first transition portion 442 and the second transition portion 444 are each also comprised of a flexible foam, but are typically comprised of a flexible foam having a density and/or hardness less than that of the outer portion 430 of the pillow 410 and greater than that of the interior portion 420 of the pillow 410. As such, by including a first transition portion 442 and a second transition portion 444 in the pillow 410, a user resting on the pillow is provided with an amount of firmness and support that gradually decreases from the outer portion 430 to the interior portion 420 of the pillow 410.

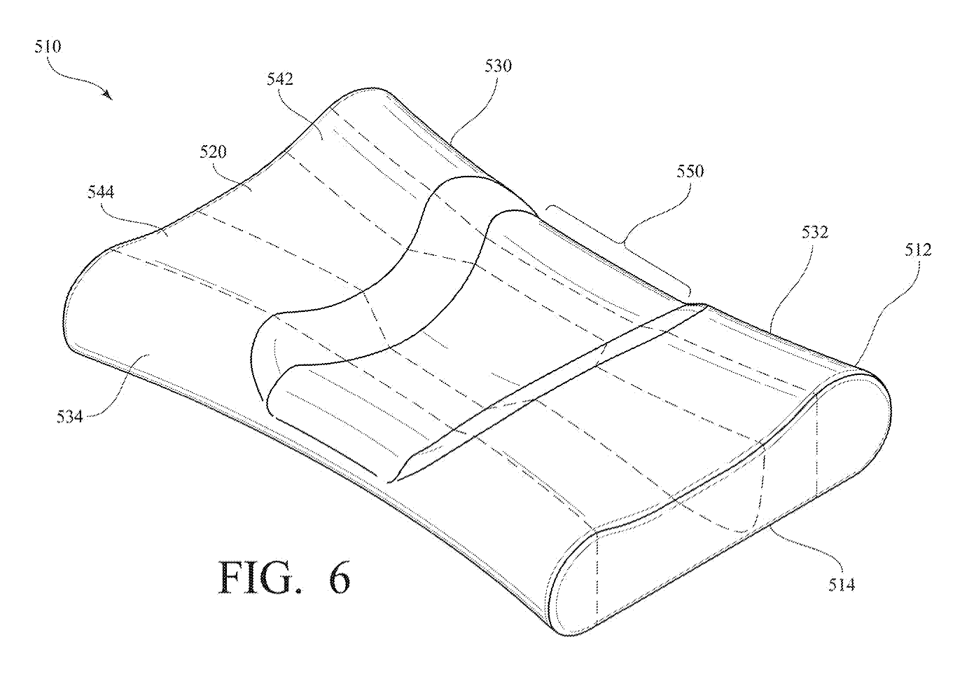

Of course, exemplary pillows having an amount of firmness and support that gradually decreases from the outer portion to the interior portion of the pillow can also be provided in a number of additional configurations without departing from the spirit and scope of the present invention. For example, and referring now to FIG. 6, in another exemplary embodiment, a support cushion in the form of a pillow 510 is provided that, similar to the pillow 410 shown in FIG. 5, also includes: an interior portion 520; an outer portion 530 comprised of an upper area 532 and a lower area 534; a first transition area 542 positioned between the interior portion 520 and the upper area 532; and a second transition area 544 positioned between the interior portion 520 and the lower area 534 of the outer portion 530. Collectively the interior portion 520, the upper area 532 and the lower area 534 of the outer portion 530, and the first transition portion 542 and the second transition portion 544 define a first, upper surface 512 and a second, bottom surface 514 of the pillow 510. However, rather than forming a continuous upper surface such as what is included in the pillow 410 shown in FIG. 5, the interior portion 520, the upper area 532 and the lower area 534 of the outer portion 530, and the first transition, portion 542 and second transition portion 544 of the pillow 510 collectively define a central recess 550 in the pillow 510. In this regard, the recess 550 generally has a height that is less that is less than the height of the remainder of the pillow 510 and thus allows the pillow 510 to accommodate a user who prefers to sleep both on his or her side or back.

As a further refinement to the exemplary pillows of the present invention, various covers and materials can also be included and used with the exemplary pillows. For example, it is contemplated that a pillow of the present invention can further include a cover in the form of a fire sock that surrounds the various portions of a pillow and is comprised of a flame retardant material. In some embodiments, an exemplary cover of the present invention can also be comprised, of another textile, such as cotton, that provides a user with a sufficiently soft surface on which to rest.

In some embodiments of the exemplary pillows described herein, it is also contemplated, that an amount of phase change material can be incorporated into a first side, a second side, or both of an exemplary pillow. Such phase change material is typically comprised of microspheres that include substances having a high heat of fusion and that store or release heat as the substances oscillate between solid and liquid form (i.e., phase change materials). As the phase change material changes from solid to liquid form (i.e., melts) as the result of heat generated by a user lying on an exemplary pillow, the phase change material thus continually absorbs heat and provides a cooling effect to the user until all of the phase change material has been transformed from a solid to a liquid form.

As vet another refinement to the present invention, although the support cushions shown in FIGS. 1-6 are in the form of a pillow and are dimensionally sized to support the head, neck, and shoulders of a user, it is contemplated that the features described herein are equally applicable to mattresses, seat cushions, seat backs, neck pillows, leg spacer pillows, mattress toppers, overlays, and the like. As such, the phrase “support cushion” is used herein to refer to any and all such objects having any size and shape, and that are capable of or are generally used to support the body of a user or a portion thereof.

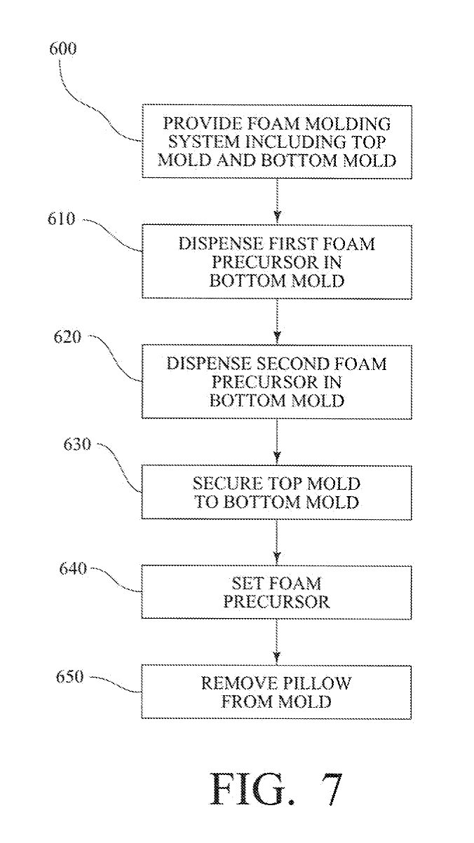

Regardless of the particular type of support cushion contemplated by the present invention, each of the exemplary support cushions described herein are typically produced by making use of a foam molding system. In one exemplary implementation of a method for producing a pillow, such as the pillow 10 described above, and referring now to FIG. 7, a foam molding system is first provided, as indicated by step 600. The foam molding system comprises a top mold and a bottom mold, with the top mold defining a recessed portion and the bottom mold similarly defining a recessed portion as is recognized in the art. In this regard, when the top mold is secured to the bottom mold, the recessed portion of the top mold and the recessed portion of the bottom mold align with one another to form a single internal cavity that in, in turn, is the negative of the pillow produced by the foam molding system (e.g., the pillow 10 described above with reference to FIGS. 1A-1B).

Referring still to FIG. 7, upon providing the foam molding system, a first foam precursor is then dispensed into a central portion of the bottom mold, as indicated by step 610. After the first foam precursor is dispensed into a central portion of the bottom mold, a second foam precursor is then dispensed into a peripheral portion of the mold, as indicated by step 620. As would be recognized by those of skill in the art such foam precursors are generally a liquid composition that includes one or more polymeric precursors and that, upon curing, forms a solid loam product (e.g., a pillow). For instance, in one exemplary implementation, the first and second foam precursors dispensed into the bottom mold of the foam molding system are each a visco-elastic foam precursor that is comprised of isocyanate, polyol, and other additives known in the art, and which, upon curing, are capable of forming the first flexible foam (e.g., visco-elastic foam) and the second flexible foam (e.g., visco-elastic foam) of the interior portion 20 and the outer portion 30, respectively, of the pillow 10 described above with, reference to FIG. 1.

In some embodiments, such foam precursors can be applied separately to produce a first and second flexible foam in an exemplary pillow. In other embodiments, however, the foam precursors can be applied as part of a continuous process whereby the isocyante index and shot weight of a particular foam precursor is varied over the course of being continually dispensed into a mold so as to produce a support cushion having variable densities, such as those described herein above. As such, the terms “first foam precursor” and “second foam precursor” are used herein to refer to two separate compositions that are used to produce a support cushion in accordance with the present invention, but are further inclusive of single compositions where the ingredients are varied over time to produce flexible foam having variable properties.

Irrespective of the particular manner in which the foam precursor is dispensed, and referring still to FIG. 7, after dispensing the first and second foam precursors into the bottom mold, the top mold is then secured to the bottom mold, as indicated by step 630. Upon securing the top mold to the bottom mold, the first and second foam precursors are then allowed to expand and completely fill the internal cavity formed from the recessed portions of the top mold and the bottom mold. After the first and second foam precursor expands, the first and second foam precursors then set in the foam molding system such that the expanded foam formed from the first foam precursor (e.g., the first flexible foam of the interior portion 20 of the pillow 10) is bonded to or otherwise combines with the expanded foam formed from the second foam precursor (i.e., the second flexible foam of the outer portion 30 of the pillow 10), as indicated by step 640. In some embodiments, the time required for the foam precursor to fully expand and set is about 10 to about 15 minutes, and in one preferred embodiment, the time is about 12 minutes, it is appreciated, however, that the time required for the foam precursor to set will depend on the particular components of the foam precursor and that foam precursors having a particular setting time can readily be ascertained and selected by one skilled in the art.

Alter the foam precursor has reacted for an appropriate amount of time and the first and second foam precursors have set, a pillow is thereby formed and can then be removed from the foam molding system, as indicated by step 650. Specifically, to remove the pillow from the foam molding system, the top mold is removed from the bottom mold to allow the resulting pillow to be easily lifted from the bottom mold and fully cured outside of the foam molding system. In some implementations, the curing of an exemplary pillow produced by the present invention can take about 2 hours to about 4 hours, with an additional amount of time to allow the exothermic reaction of the foam precursor to complete and to allow the resulting pillow to fully cool. Of course, the pillow may also cure within the foam molding system itself; however, because of the extended curing time, in some implementations, it is more economical to remove the pillow and allow the foam precursor to cure separate from the foam molding system so that steps 600-650 may be repeated in the production of additional pillows or support cushions.

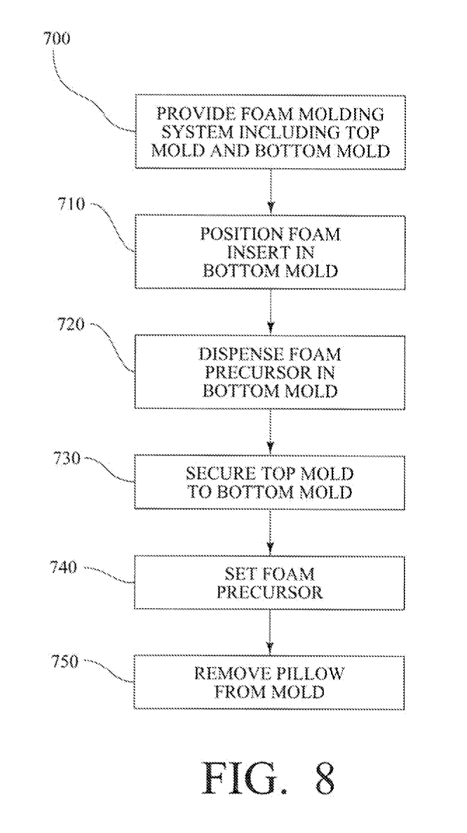

Referring now to FIG. 8, in an alternative method for producing a pillow in accordance with the present invention, such as the pillow 10 described above, a foam molding system is first provided, as Indicated by step 700, that is substantially identical to the foam molding system described above with reference to FIG. 7. Specifically, the foam molding system comprises a top mold and a bottom mold, with the top mold defining a recessed portion and the bottom mold similarly defining a recessed portion such that when the top mold is secured to the bottom mold, the recessed portion of the top mold and the recessed portion of the bottom mold align with one another to form a single internal cavity that in, in turn, is the negative of the pillow produced by the loam molding system.

Referring still to FIG. 8, upon providing the foam molding system, a foam insert that has previously been produced is placed into a central portion of the bottom mold, as indicated by step 710. After the foam insert is placed into a central portion of the bottom mold, a foam precursor is then dispensed into the bottom mold around the loam insert, as indicated by step 720. Then, after dispensing the foam precursor into the bottom mold around the loam insert, the top mold is secured to the bottom mold, as indicated by step 730. Upon securing the top mold to the bottom mold, the foam precursor is then allowed to expand and completely fill the internal cavity formed from the recessed portions of the top mold and the bottom mold.

After the foam precursor expands, the foam precursor then sets in the foam molding system such that the resulting expanded foam is bonded to the foam insert, as indicated by step 740. Subsequently, after the foam precursor has been allowed to react for an appropriate amount of time and the foam precursor has set, an exemplary pillow of the present invention is thereby formed wherein the foam insert forms the interior portion of the exemplary pillow and the set foam precursor forms the outer portion of the exemplary pillow. The pillow can then be removed from the foam molding system, as indicated by step 750.

One of ordinary skill in the art will recognize that additional embodiments are also possible without departing from the teachings of the present invention or the scope of the claims which follow, This detailed description, and particularly the specific details of the exemplary embodiments disclosed herein, is given primarily for clarity of understanding, and no unnecessary limitations are to be understood therefrom, for modifications will become apparent to those skilled in the art upon reading this disclosure and may be made without departing from the spirit or scope of the claimed invention.

What is claimed is

1. A pillow, comprising:
an inferior portion comprised of a first flexible foam, the interior portion defining a perimeter; and
an outer portion comprised of a second flexible foam and extending along at least part of the perimeter of the interior portion, the second flexible foam having a density different than that of the first flexible foam.

2. The pillow of claim 1, wherein the interior portion, the outer portion, or both are comprised of a visco-elastic foam.

3. The pillow of claim 1, further comprising a cover surrounding the interior portion and the outer portion.

4. The pillow of claim 1, wherein the interior portion is configured to support a head of a user and the outer portion is configured to support a neck and shoulders of the user.

5. The pillow of claim 1, wherein the density of the first flexible foam is less than the density of the second flexible foam.

6. The pillow of claim 5, wherein the first flexible foam has a density of about 30 kg/m³ to about 50 kg/m³, and wherein the second flexible foam has a density of about 70 kg/m³ to about 110 kg/m³.

7. The pillow of claim 6, wherein the first flexible foam has a density of about 40 kg/m³and the second flexible foam has a density of about 100 kg/m³.

8. The pillow of claim 1, wherein the first flexible foam has a hardness less than that of the second flexible foam.

9. The pillow of claim 8, wherein the hardness of the first, flexible is about 5 N to about 25 N, and wherein the hardness of the second flexible foam is about 25 N to about 50 N.

10. The pillow of claim 9, wherein the hardness of the first flexible foam is about 10 N and the hardness of the second flexible foam is about 45 N.

11. The pillow of claim 1, wherein the outer portion entirely surrounds the perimeter of the interior portion.

12. The pillow of claim 11, wherein the interior portion is recessed relative to the outer portion of the pillow.

13. The pillow of claim 12, wherein the outer portion defines one or more divots positioned and having a shape configured to support a neck of a user.

14. The pillow of claim 12, wherein, the outer portion includes a first side, a second side, a third side, and a fourth side, the first side and the second side of the outer portion being continuous with one another and each having a first height, and the third side and the fourth side being continuous with one another and each having a second height less than the first height.

15. The pillow of claim 1, wherein the pillow has a contoured shape.

16. A pillow, comprising a flexible foam body including an interior portion and an outer portion, the flexible foam body having a density that decreases as the flexible foam body extends from the interior portion to the outer portion.

17. The pillow of claim 16, wherein the outer portion comprises an upper area and a
lower area of the flexible foam body, and wherein the interior portion is positioned between the upper area and the lower area of the outer portion.

18. The pillow of claim 17, wherein the flexible foam body further comprises a first transition portion positioned between the interior portion and the upper area of the outer portion and a second transition portion positioned between the interior portion and the lower area of the outer portion, the first transition port ion and the second transition portion each having a density different than that of both the interior portion and the outer portion.

19. A method of producing a pillow, comprising the steps of:
dispensing a first foam precursor into a central portion of a mold to produce a first flexible foam; and
dispensing a second foam precursor into a peripheral portion of the mold to produce a second flexible foam having a density different than that of the first flexible foam,
wherein, upon reaction and expansion of the first foam precursor and the second foam precursor, a molded foam pillow is produced having an interior portion with a density different than that of an outer portion of the pillow.

20. The method of claim 19, further comprising the step of setting the first foam precursor and the second foam precursor in the mold for an amount of time sufficient to allow the first foam precursor and the second foam precursor to bond together.

21. The method of claim 19, wherein the first foam precursor, the second foam precursor, or both are a visco-elastic foam precursor.

22. A method of producing a pillow, comprising the steps of:
placing a foam insert, comprised of a first flexible foam into a central portion of a mold; and
dispensing a foam precursor around the foam insert to produce a second flexible foam having a density different than that of the first flexible foam,
wherein, upon reaction and expansion of the foam precursor, a molded foam pillow is produced having an interior portion with a density different than that of an outer portion of the pillow.

23. The method of claim 22, further comprising the step of setting the foam precursor in the mold for an amount of time sufficient, to allow the foam insert to bond to the setting foam precursor.

24. The method of claim 22, wherein the foam precursor is a visco-elastic foam precursor.
